(19) United States
(12) Patent Application Publication
(10) Pub. No.: US 2017/0108803 A1
(43) Pub. Date: Apr. 20, 2017

(54) TRANSFER STATION, PRINTER AND METHOD FOR IMPROVING TONER TRANSFER

(71) Applicant: Océ Printing Systems GmbH & Co. KG, Poing (DE)

(72) Inventor: Andreas Paul, Vaterstetten (DE)

(73) Assignee: Océ Printing Systems GmbH & Co. KG, Poing (DE)

(21) Appl. No.: 15/293,918

(22) Filed: Oct. 14, 2016

(30) Foreign Application Priority Data
Oct. 14, 2015 (DE) 102015117453.7

(51) Int. Cl. G03G 15/16

(52) U.S. Cl. CPC G03G 15/161

(57) ABSTRACT

In a transfer station of a toner-based print group, the counter-pressure roller can be arranged offset from the print image roller. For example, a rotation axis of the counter-pressure roller is arranged after a rotation axis of the print image roller in the transport direction. The counter-pressure roller and print image roller can cooperatively create a nip, where the in a runout region of the nip, the contact of the recording medium with the print image roller is ends while the recording medium remains in contact with the counter-pressure roller.

### CROSS REFERENCE TO RELATED APPLICATIONS

This patent application claims priority to German Patent Application No. 102015117453.7, filed Oct. 14, 2015, which is incorporated herein by reference in its entirety.

### BACKGROUND

Field

The disclosure is directed to a method and a transfer station via which the toner transfer in a toner-based printer may be improved.

Related Art

In toner-based digital printing, a latent charge image (given an electrographic printer) or a latent magnetic image (given a magnetographic printer) of an image carrier is inked with toner (e.g., liquid toner or dry toner). The toner image that is created in such a manner is transferred onto a recording medium directly from the image carrier or indirectly at a transfer location under the effect of an electrical and/or magnetic field.

To achieve a high print quality, it is desirable that the toner image is transferred as completely as possible from the image carrier (e.g., from a transfer roller) onto the recording medium at the transfer location. The transfer printing of the toner image at the transfer location thereby typically depends on properties of the transfer location.

EP1351100A1, JP2007-041124A, U.S. Patent Application Publication No. 2006/0019189A1, U.S. Pat. No. 8,891,988B2, and JP2013-040987A describe printing systems in which print images are transferred from a photoconductor roller onto a transfer belt. The printing systems respectively comprise a transfer roller on the back side of the transfer belt that is offset relative to the photoconductor roller.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a digital printer according to an exemplary embodiment of the present disclosure.

FIG. 2 illustrates an exemplary embodiment of a print group of the digital printer of FIG. 1.

FIGS. 3a and 3b illustrate the guidance of a recording medium through the print group according to an exemplary embodiment of the present disclosure.

FIGS. 4a and 4b illustrate the guidance of a recording medium through a print group according to an exemplary embodiment of the present disclosure.

FIG. 5 illustrates a workflow diagram of a method for printing to a recording medium according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure is to provide a geometric arrangement of the transfer location via which the quality of the transfer printing of the toner image is increased.

According to one aspect, a transfer station for a print group of a toner-based printer is described. The transfer station comprises a print image carrier that is configured to transfer a print image inked with toner from the print image carrier to a recording medium, at a transfer location. The print image carrier thereby comprises a print image roller.

Furthermore, the transfer station comprises a counter-pressure roller that is configured to press the recording medium against the print image carrier—and in particular against the print image roller—at the transfer location. The recording medium thereby has a transport direction through the transfer station. The rotation axis of the counter-pressure roller is arranged after the rotation axis of the print image roller in the transport direction. The quality of the transfer printing of the toner image may thus be increased.

According to a further aspect, a method is described for printing to a recording medium. The method includes the guidance of the recording medium to a transfer location between a print image carrier and a counter-pressure roller so that the recording medium initially comes into contact with the print image carrier and only subsequently comes into contact with the counter-pressure roller. Furthermore, the method includes the transfer of a print image inked with toner from the print image carrier onto the recording medium. Moreover, the method includes the guidance of the recording medium away from the transfer location so that the recording medium first loses contact with the print image carrier and only subsequently loses contact with the counter-pressure roller.

According to a further aspect, a print group for a toner-based printer is described. The print group comprises the transfer station described in this document.

According to a further aspect, a printer for printing to a recording medium is described. The printer comprises a plurality of print groups that are configured to print a corresponding plurality of toner-based print images in succession onto a first side (for example onto a front side) of the recording medium. The printer is thereby designed such that the first side (i.e. the printed side) of the recording medium only makes contact with the print image carriers of the transfer stations of the plurality of print groups between an intake of a first print group of the plurality of print groups and an exit of a last print group of the plurality of print groups. The printer thus has no additional contact point with the first side of the recording medium via which the print images could be damaged. In particular, the printer has no additional deflection points (for example deflection rollers) via which the print images on the first side of the recording medium could be damaged. A necessary tensile stress of the recording medium may be produced by the offset of the rotation axes of print image roller and counter-pressure roller in the transfer stations.

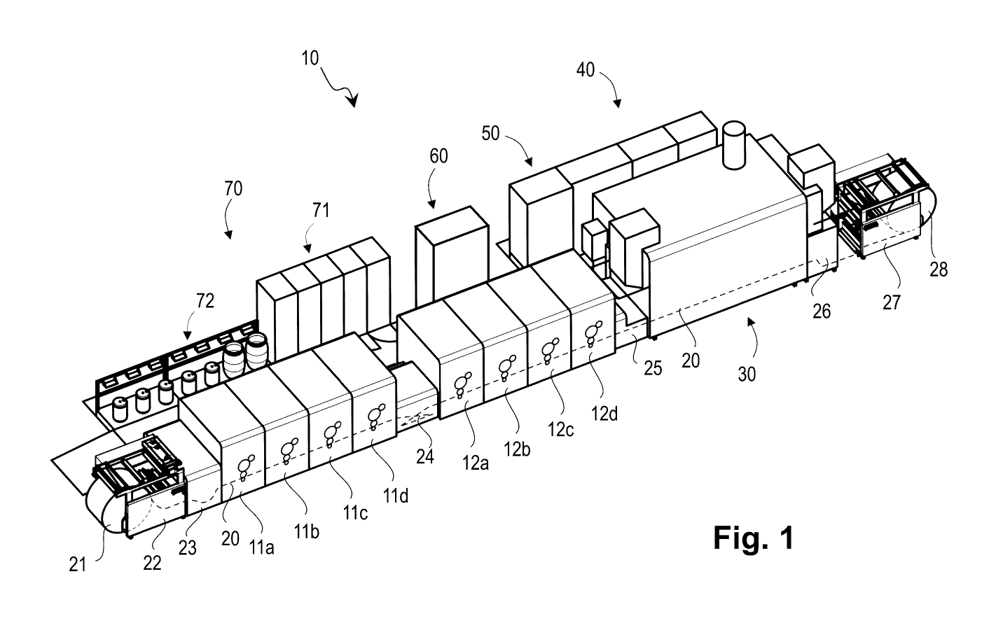

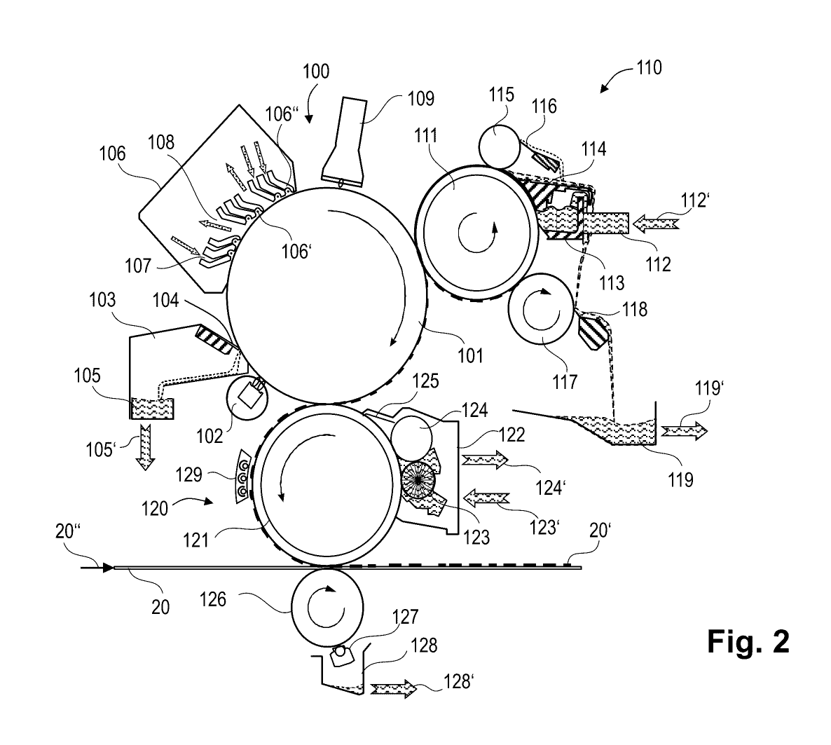

FIG. 1 illustrates a digital printer 10 according to an exemplary embodiment of the present disclosure. The digital printer 10 can be configured to print to a recording medium 20, and can include one or more print groups 11a-11d and 12a-12d that print a toner image (print image 20′; see FIG. 2) onto the recording medium 20. As shown, a recording medium 20 (e.g., a web-shaped recording medium 20) is unrolled from a roll 21 with the aid of a take-off 22 and is continuously supplied to the first print group 11a. The print image 20′ is fixed on the recording medium 20 in a fixer 30. The recording medium 20 may subsequently be taken up on a roll 28 with the aid of a take-up 27. Such a configuration is also designated as a roll-to-roll printer. Further details and examples of the digital printer 10 are described in the patent document DE 10 2013 201 549 B3, as well as in the corresponding patent applications JP 2014/149526 A and U.S. Patent Application No. 2014/0212632 A1. Each of these patent documents is herein incorporated by reference in its entirety.

FIG. 2 illustrates an exemplary embodiment of a print group 11, 12. The print group depicted in FIG. 2 is based on the electrophotographic principle, given which a photoelectric image carrier (in particular a photoconductor 101) is inked with charged toner particles with the aid of a liquid developer or liquid toner, and the toner image that is created in such a manner is transferred to the recording medium 20. The print group 11, 12 can include an electrophotography station 100, a developer station 110 and a transfer station 120.

The core of the electrophotography station 100 is a photoelectric image carrier that has a photoelectric layer (what is known as a photoconductor) on its surface. The photoconductor here is designed as a roller (photoconductor roller 101) and has a hard surface. The photoconductor roller 101 rotates past the various elements to generate a print image 20′ (rotation in the arrow direction).

The electrophotography station 100 comprises a character generator 109 that generates a latent image on the photoconductor 101. The latent image is inked with toner particles by the developer station 110 in order to generate an inked image (i.e. a toner image). For this, the developer station 110 has a rotating developer roller 111 that brings a layer of liquid developer onto the photoconductor 101.

The inked image rotates with the photoconductor roller 101 up to a first transfer location, at which the inked image is essentially completely transferred onto a transfer roller 121. The recording medium 20 travels in the transport direction 20″ between the transfer roller 121 and a counter-pressure roller 126. The contact region (nip) represents a second transfer location in which the toner image is transferred onto the recording medium 20. Additional details and examples of the print group 11, 12 are described in the patent document DE 10 2013 201 549 B3, as well as in the corresponding patent applications JP 2014/149526 A and U.S. Patent Application Publication No. 2014/0212632 A1.

In particular given the use of liquid toner or liquid developer, an insufficient transfer of toner from the transfer roller 121 onto the recording medium 20 (in particular onto cardboard) may occur. The toner transfer is thereby produced primarily by the electrical field, which acts on the toner (i.e. on the charged toner particles) in the roller nip between transfer roller 121 and counter-pressure roller 126. The electrical field has the effect that toner within the roller nip releases from the transfer roller 121 and is pushed towards the surface of the recording medium. In addition to such electrical effects, flow and absorption effects lead to a displacement of carrier fluid and toner particles and thus influence the toner transfer.

It has been shown that the toner transfer may be improved via an optimally long contact zone (in the transport direction 20″) between transfer roller 121 and recording medium 20. A long contact zone or a long roller nip may be produced via a relatively high contact pressure between counter-pressure roller 126 and transfer roller 121, as well as via the use of a relatively soft (and therefore typically sensitive) coating of the transfer roller 121. Furthermore, the toner transfer may typically be improved by increasing the field strength of the electrical field in the roller nip. For this purpose, a potential difference applied between transfer roller 121 and counter-pressure roller 126 may be increased.

Properties of the edge region (i.e. of the intake region and the runout region of the roller nip) of the transfer location (i.e. of the roller nip) between transfer roller 121 and recording medium 20 have also turned out to be an additional factor for the quality of the toner transfer. In particular, it has been observed that the quality of the toner transfer may be increased via a relatively high field strength of the electrical field in the runout region of the roller nip (which may also be designated as a separating zone).

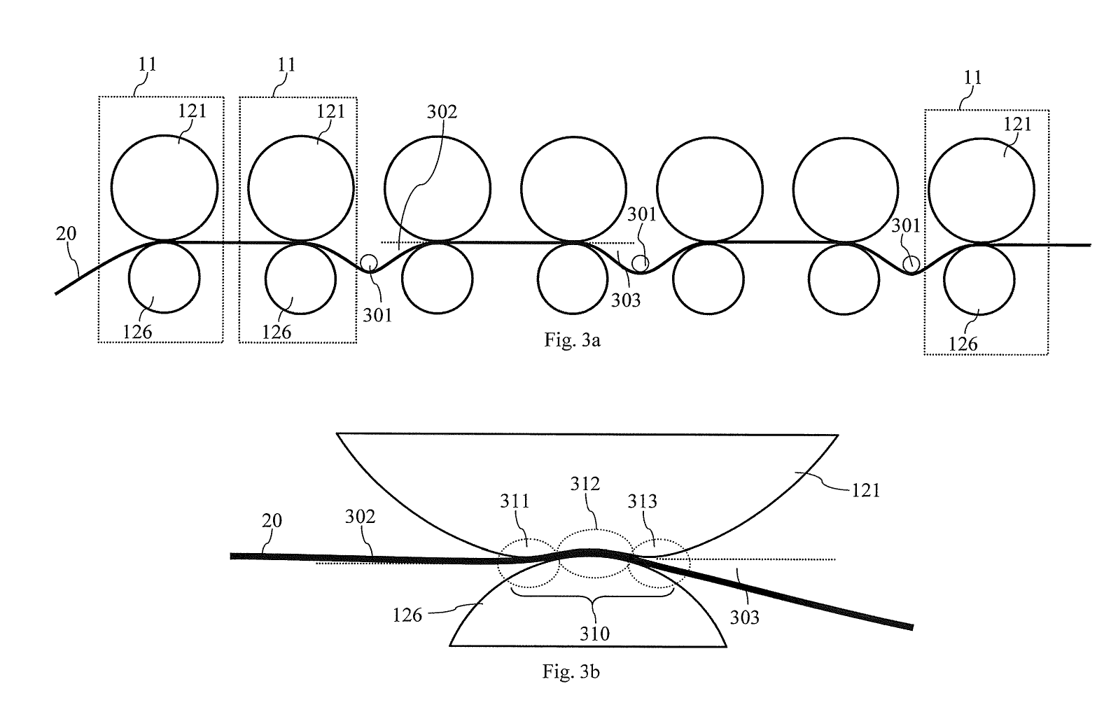

FIG. 3a illustrates a side view of an example course of a recording medium 20 through a printer 10 having a plurality of print groups 11. In an exemplary embodiment, the transfer roller 121 is arranged symmetrically with the counter-pressure roller 126. In particular, a connecting line between the rotation axes of the transfer roller 121 and the counter-pressure roller 126 is most often orthogonal relative to the transport direction 20″ of the recording medium 20. As a result of this, the contact points of transfer roller 121 with recording medium 20 in the intake region 311 and in the runout region 313 of the roller nip 310, or the contact points of recording medium 20 with counter-pressure roller 126 in the intake region 311 and in the runout region 313 of the roller nip 310, are for the most part of nearly identical design (see FIG. 3b), in particular if no deflection rollers 301 are used.

As illustrated in FIG. 3a, in an exemplary embodiment, the recording medium 20 is directed (mostly) horizontally between two adjacent print groups 11. If applicable, a tensioning roller 301 may be arranged between two print groups 11, which may be used to tension the recording medium 20 to ensure a uniform running of the recording medium 20 through the plurality of print groups 11. The deviation of the course of the recording medium 20 from a horizontal course that is produced by a tensioning roller 301 is shown with emphasis in FIG. 3a. In an exemplary embodiment, intake angle 302 of, for example, approximately 4° or less in the intake region 311 of a roller nip 310 and/or runout angle 303 of, for example, approximately 4° or less result in the runout region 313 of a roller nip 310 given the use of a tensioning roller. The intake angle 302 and the runout angle 303 are not limited to these example angular values and can be other angular values as would be understood by one of ordinary skill in the relevant arts.

FIG. 3b illustrates an example course of a recording medium 20 in a print group 11 that has no tensioning roller 301 at the intake and a tensioning roller 301 at the runout. The recording medium 20 therefore runs nearly horizontally (with an intake angle 302 of, for example, nearly 0°) in the intake region 311 of the roller nip (i.e. the transfer location) 310.

FIG. 3b additionally shows the central region 312 of the roller nip 310 in which both a contact between transfer roller 121 and recording medium 20 and a contact between recording medium 20 and counter-pressure roller 126 are present. Furthermore, FIG. 3b shows the runout region 313 of the roller nip 310 in which—due to a tensioning roller 301—the recording medium 20 leaves with a runout angle 303 of approximately 4° relative to the horizontal of the roller nip 310.

As illustrated in FIG. 3b, in the intake region 311, the transfer roller contact between transfer roller 121 and recording medium 20 takes place (e.g., nearly simultaneously) with the counter-pressure roller contact between recording medium 20 and counter-pressure roller 126. The situation is similar in the runout region 313. This leads to the situation that the application or the phase-out of the electrical field in the roller nip 310 are subject to random fluctuations. In particular, the transfer roller contact may be established or disappear at random before the counter-pressure roller contact, which leads to a different electrical field in the intake region 311 or in the runout region 313 than if first the counter-pressure roller contact and then the transfer roller contact are established or disappear.

Such random fluctuations may be reduced via a precise web compensation of the recording medium 20, i.e. via a precise guidance of a tensioned recording medium 20. Moreover, however, in the intake region 311 the surface velocity of the transfer roller 121 is typically lower than the velocity of the web-shaped recording medium 20. Given a nearly simultaneous establishment of the transfer roller contact and of the counter-pressure roller contact, this leads to a shear of the recording medium 20 in the intake region 311 of the roller nip 310.

Overall, given the embodiment of the roller nip 310 that is depicted in FIG. 3b, different artifacts may occur in a print image on the recording medium 20, for example an incomplete toner transfer, locally different inkings (cloudiness, mottling), print image disruptions such as a flowing of the print images (i.e. a lateral toner transport into regions in which no toner should be transferred), and/or defects on the recording medium 20 that are incorrectly not covered with toner. Such artifacts may in particular arise due to shear effects in the intake region 311 of the roller nip 310. The measures described in the present disclosure enable a shear of the recording medium 20 to be displaced toward an inner region 312 of the roller nip 310 that is situated after the intake region 311, and thereby enable artifacts in the print image to be reduced.

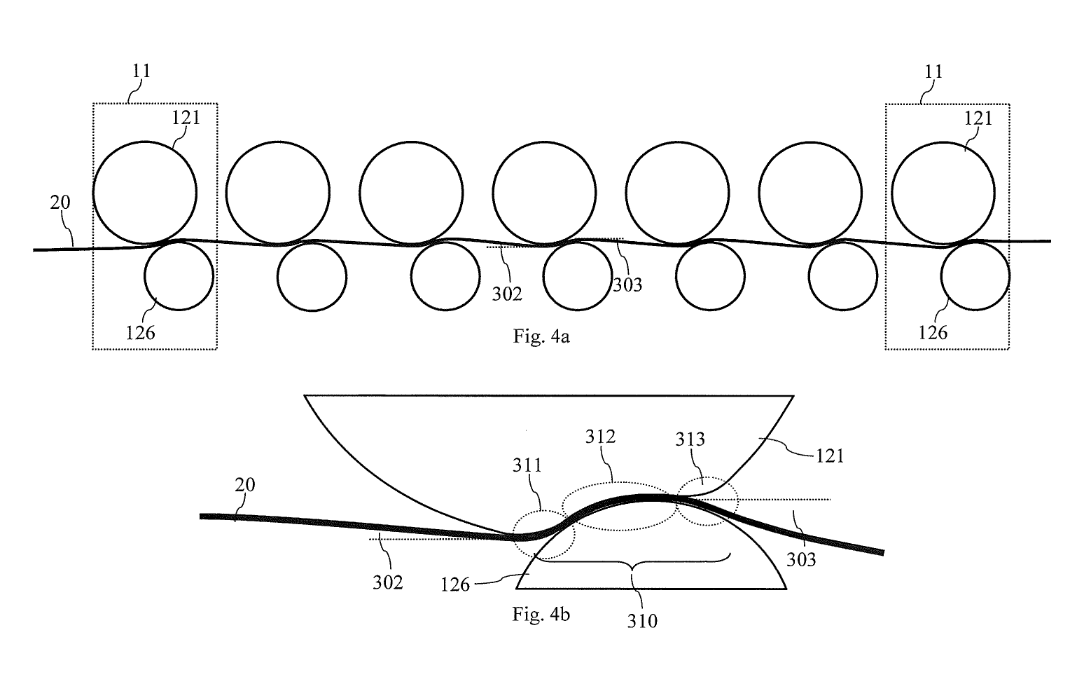

FIGS. 4a and 4b illustrate a transfer station 120 for print groups 11 according to an exemplary embodiment via which defined properties of the intake region 311 and/or of the runout region 313 of a roller nip 310 are enabled. As illustrated in FIGS. 4a and 4b, the transfer roller 121 and the counter-pressure roller 126 of a transfer station 120 can be arranged relative to one another such that the connecting line between the rotation axis of the transfer roller 121 and the rotation axis of the counter-pressure roller 126 no longer travels orthogonal to the (average) transport direction 20″ of the recording medium 20 through the transfer station 120. In particular, the rotation axis of the counter-pressure roller 126 is located after the rotation axis of the transfer roller 121 in the transport direction 20″.

Via such an arrangement of transfer roller 121 and counter-pressure roller 126, the recording medium 20 may be tensioned without using tensioning rollers 301. This is advantageous since an unfixed print image on the surface of the recording medium 20 can no longer be damaged by the surface of a tensioning roller 301.

An additional advantage is clear from FIG. 3b. In particular, it is clear that the transfer roller contact reliably takes place chronologically before the counter-pressure roller contact in the intake region 311 of the roller nip 310. Furthermore, in the runout region 313 the transfer roller contact is reliably released chronologically before the counter-pressure roller contact. The intake region 311 and/or the runout region 313 of the roller nip 310 thus have defined relationships and are no longer subject to random fluctuations.

Via the arrangement depicted in FIG. 3b it may in particular be ensured in the runout region 313 that an electrical field having a high field strength continues to be present at the point in time at which the transfer roller 121 is separated from the recording medium 20, since the recording medium 20 continues to be in contact with the counter-pressure roller 126 at this point in time. A reliable toner transfer may thus be ensured via the electrical field. In particular, a return transfer of toner from the recording medium 20 back to the transfer roller 121 may be avoided via the electrical field.

Via an offset (toward the rear in the transport direction 20″) counter-pressure roller 126, a clear decoupling of the points in time of the establishment or release of the transfer roller contact and of the counter-pressure roller contact in the intake region 311 and in the runout region 313 may thus be produced. In particular, it may be produced that, in the intake region 311, the recording medium 20 initially makes contact with the transfer roller 121 and only subsequently makes contact with the counter-pressure roller 126. Shear forces in the intake region 311 may thus be reduced. Furthermore, it may be brought about that, in the runout region 313, the recording medium 20 is initially separated from the transfer roller 121 so that a complete toner transfer is ensured via an optimally strong electrical field. Moreover, the wrapping of the transfer roller 121—and therefore the length of the roller nip 310 (in the transport direction 20″)—may be increased via the offset of the counter-pressure roller 126, which leads to an increase of the efficiency of the toner transfer. On the other hand, the mechanical contact pressure force between counter-pressure roller 126 and transfer roller 121 may be reduced due to the larger inherent length of the roller nip 310, whereby shear forces in the roller nip 310 may be reduced.

In an exemplary embodiment, in a transfer station 120, a relatively soft transfer roller 121 (for example with an elastomer layer at the surface) and a relatively hard counter-pressure roller 126 can be used. As a result of this, a roller nip 310 is created that is oriented toward the transfer roller 121. On the other hand, a relatively hard transfer roller 121 and a relatively soft counter-pressure roller 126 may be used so that a roller nip 310 results that is oriented toward the counter-pressure roller 126. The measures described in this document are applicable to both cases.

In an exemplary embodiment, a transfer station 120 for a print group 11 of a toner-based printer 10 includes a print image carrier 121 that is configured to transfer a print image inked with toner from the print image carrier 121 onto a recording medium 20 at a transfer location 310 (i.e. at a roller nip). The print image carrier 121 thereby comprises a print image roller 121. In particular, the print image carrier 121 may comprise a print image roller 121 (e.g., a transfer roller 121 or a photoconductor 101) that is configured to carry the print image directly onto a surface of the print image roller 121 at the transfer location 310. The print image is then transferred directly from the surface of the print image roller 121 onto the recording medium 20 at the transfer location 310. Alternatively, the print image carrier 121 may comprise a print image belt that carries the print image to the transfer location 310. The print image roller 121 may then be used to press the print image belt onto the recording medium 20 at the transfer location 310 in order to assist in a transfer of the print image onto the recording medium 20. In a preferred example, the print image carrier 121 corresponds to the transfer roller 121 described in this document.

In an exemplary embodiment, the transfer station 120 comprises a counter-pressure roller 126 that is configured to press the recording medium 20 against the print image roller 121 at the transfer location 310. The recording medium 20 may be web-shaped and be supplied continuously to the transfer station.

In an exemplary embodiment, the recording medium 20 is thus guided through between the print image carrier 121 (in particular between the print image roller 121) and the counter-pressure roller 126. The recording medium 20 is thereby guided through the transfer station 120 in a defined transport direction 20″. The transport direction 20″ of the recording medium 20 through the transfer station 120 thereby typically corresponds to a direction that runs horizontally or parallel to a floor on which the print group 11 and/or the printer 10 are arranged. To determine the transport direction 20″ of the recording medium 20 through the transfer station 120, a first point may be determined at which the recording medium 20 enters into the transfer station 120 (or into the print group 11), and a second point may be determined at which the recording medium 20 exits from the transfer station 120 (or from the print group 11). A connecting line between the first and second point may indicate the (possibly average) transport direction 20″ of the recording medium 20 through the transfer station 120.

In an exemplary embodiment, the print image roller 121 and the counter-pressure roller 126 may be arranged such that a rotation axis of the counter-pressure roller 126 is arranged after a rotation axis of the print image roller 121 in the transport direction 20″. In particular, the rotation axis of the counter-pressure roller 126 may be arranged after the rotation axis of the print image roller 121 such that a ratio of a distance between the rotation axes in the transport direction 20″ and a direct distance between the rotation axes is greater than or equal to, for example, 5%, 10%, 15% or 20%, but are not limited thereto. The quality of the toner transfer may be increased via an offset of the rotation axes of the print image roller 121 and the counter-pressure roller 126. Furthermore, the recording medium 20 may be tensioned via such an offset, which leads to an improved guidance of the recording medium 20 through a printer 10.

In an exemplary embodiment, the print image roller 121 has a radius of, for example, 90 mm and the counter-pressure roller has a radius of, for example, 45 mm, but are not limited thereto. The rotation axis of the counter-pressure roller 126 may, for example, be arranged 10 mm or more behind the rotation axis of the print image roller 121 in the transport direction 20″, but is not limited thereto. The direct distance between the rotation axes then amounts to somewhat more than, for example, 135 mm, and the ratio of the distance in the transport direction 20″ (e.g., 10 mm) and the direct distance amounts to, for example, approximately 7%.

The print image on the print image carrier 121 may be inked with a liquid toner, wherein the liquid toner comprises (possibly electrically charged) toner particles and a carrier fluid. The offset of print image roller 121 and counter-pressure roller 126 according to exemplary embodiments is particularly advantageous given the use of liquid toner, since the flow behaviors of the liquid toner at the transfer location 310 (i.e. in the roller nip) may be better controlled due to the offset.

In an exemplary embodiment, the transfer station may comprise a voltage source that is configured to generate a potential difference between the print image carrier 121 (in particular between the print image roller 121) and the counter-pressure roller 126. The voltage source may be regulated in order to set a defined electrical field strength at the transfer location 310 and/or a defined current between print image carrier 121 and counter-pressure roller 126. Furthermore, the toner of the print image (in particular the toner particles of a liquid toner) on the print image carrier 121 may be electrically charged. The toner transfer may thus be assisted by the effect of an electrical field. The offset of the print image roller 121 and the counter-pressure roller 126 is particularly advantageous for an electrically assisted toner transfer, since the offset enables an improved control of the electrical field at the transfer location 310 (in particular in a runout region 313 of the transfer location 310).

In an exemplary embodiment, the transfer location 310 comprises a runout region 313 in which the recording medium 20 leaves the transfer location 310 after transfer of the print image. The rotation axis of the counter-pressure roller 126 may be arranged after the rotation axis of the print image roller 121 such that, in the runout region 313, a print image carrier contact between print image carrier 121 and recording medium 20 is ended chronologically before a counter-pressure roller contact between recording medium 20 and counter-pressure roller 126. In particular, the print image carrier contact may thereby be ended at a predefined minimum duration before the counter-pressure roller contact. Via such a sequence, it may be ensured—in particular given the use of an electrical field—that no return transfer of toner from the recording medium 20 onto the print image carrier 121 takes place at the runout of the transfer location 310.

In an exemplary embodiment, the transfer location 310 may comprise an intake region 311 in which the recording medium 20 approaches the transfer location 310 before transfer of the print image. The rotation axis of the counter-pressure roller 126 may be arranged after the rotation axis of the print image roller 121 such that, in the intake region 311, a print image carrier contact between print image carrier 121 and recording medium 20 is established chronologically before a counter-pressure roller contact between recording medium 20 and counter-pressure roller 126. The print image carrier contact may thereby be established at a predefined minimum duration before the counter-pressure roller contact. Via such a sequence, mechanical shear effects in the intake region 311 of the transfer location 310 may be reduced, and the quality of the toner transfer may therefore be increased.

In an exemplary embodiment, one point of the recording medium 20 may traverse the transfer location 310 within a traversal duration. A ratio between the minimum duration and the traversal duration may be, for example, 5%, 10%, or more, but is not limited thereto. The offset of the print image roller 121 and the counter-pressure roller 126 may thus lead to a reliable chronological separation of contact establishment or contact release in the intake region 311 or in the runout region 313 of the transfer location 310. The offset thus enables a reliable increase of the quality of the toner transfer.

In the present disclosure, a printer for printing to a recording medium 20 is described, wherein the printer 10 comprises, in an exemplary embodiment, a plurality of print groups 11 that are configured to successively print a corresponding plurality of toner-based print images onto a first side (in particular onto a top side or front side) of the recording medium 20. The printer 10 may thereby comprise 3 or more (for example up to 7) print groups 11, for example.

In an exemplary embodiment, the plurality of print groups 11 respectively comprise a transfer station 120 described in this document, having a print image roller 121 that is arranged offset from a counter-pressure roller 126.

In an exemplary embodiment, the printer 10 may be configured such that the first side of the recording medium 20 is in contact only with the print image carriers 121 of the transfer stations of the plurality of print groups (and in particular is not in contact with a tensioning roller 301) between an intake of a first print group 11 of the plurality of print groups 11 and an output of a last print group 11 of the plurality of print groups 11. As presented above, this is enabled via the offset between print image roller 121 and counter-pressure roller 126.

Alternatively or additionally, the print image rollers 121 and the counter-pressure rollers 126 may respectively be arranged in the transfer stations of the plurality of print groups 11 such that the recording medium 20 runs between two adjacent print groups 11 of the plurality of print groups with a defined angle 302, 303 relative to a horizontal (which is greater than 0°). It may thus be ensured that the recording medium 20 has a sufficient tensile stress within the printer 10.

In an exemplary embodiment, the offset of the rotation axis of the counter-pressure roller 126 behind the rotation axis of the print image roller 121 in the transport direction 20″ has the effect (as depicted in FIG. 4b) that the recording medium 20 leaves the transfer location 310 at a point in the runout region 313 that is situated higher by a height delta than a point in the intake region 311 at which the recording medium 20 enters into the transfer location 310. The aforementioned slanted course of the recording medium 20 between two adjacent print groups 11 may be produced via this height delta.

For example, the transfer location 310 may have a length of, for example, approximately 6 mm in the transport direction 20″, but is not limited thereto. A height delta of approximately, for example, 0.5 mm may be produced by an offset of the rotation axes by approximately, for example, 10 mm in the transport direction 20″ (given a radius of the print image roller 121 of, for example, 90 mm and a radius of the counter-pressure roller 126 of 45 mm). The exemplary embodiments are not limited to these example dimensions and the dimensions can be other dimensions as would be understood by one of ordinary skill in the relevant arts. The ratio of height delta to length of the transfer location thus amounts to approximately, for example, 8%, but is not limited thereto. The rotation axis of the counter-pressure roller 126 may thus be arranged after the print image roller 121 in the transport direction 20″ such that a ratio of height delta of the recording medium 20 to the length of the transfer location 310 amounts to, for example, 5%, 10%, or more, but is not limited thereto.

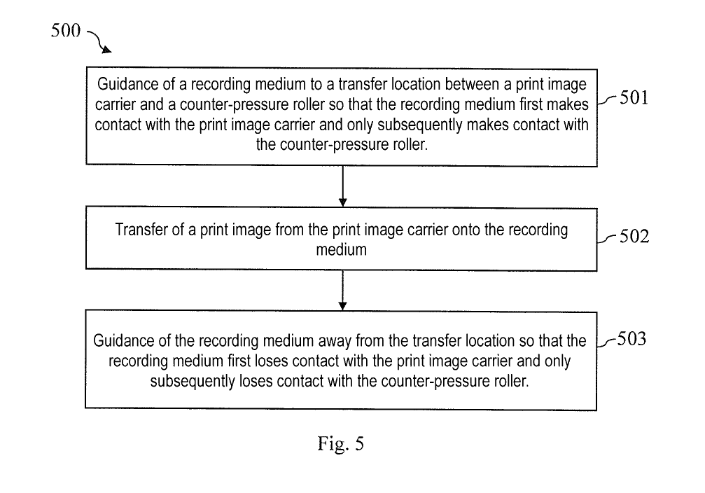

FIG. 5 illustrates a workflow diagram of a method 500 for printing to a recording medium 20 according to an exemplary embodiment of the present disclosure. The method 500 includes the guidance 501 of the recording medium 20 between a print image carrier 121 and a counter-pressure roller 126 at a transfer location 310. The recording medium 20 may thereby be directed such that the recording medium 20 first makes contact with the print image carrier 121 and only subsequently (for example after a minimum duration) makes contact with the counter-pressure roller 126. Shear effects at the intake of the transfer location 310 may thus be reduced.

In an exemplary embodiment, the method 500 additionally includes the transfer 502, at the transfer location, of a print image inked with toner from the print image carrier 121 onto the recording medium 20. The transfer 502 may preferably take place under the effect of an electrical field.

In an exemplary embodiment, the method 500 includes the guidance 503 of the recording medium 20 away from the transfer location 310. The recording medium 20 may thereby be guided such that the recording medium 20 first loses contact with the print image carrier 121 and only subsequently loses contact with the counter-pressure roller 126. A return transfer of toner from the recording medium 20 onto the print image carrier 121 may thus be prevented (in particular given the effect of an electrical field).

In the exemplary embodiments of the present disclosure, numerous advantages may be produced via the arrangement of a print image roller 121 and a counter-pressure roller 126 in a transfer station 120. The length of a roller nip 310 in the transport direction 20″ may be increased, which leads to an improved toner transfer efficiency. Furthermore, shear forces in the intake 311 of the roller nip 310 may be avoided. Quality-reducing disturbing influences may thus be reduced. In particular, liquid toner at the meniscus may move more easily, quickly and further in the intake 311 of the roller nip 310 than inside 312 the roller nip 310. Moreover, the necessary contact pressure force for achieving a defined target length of the roller nip 310 may be reduced via the arrangement of the print image roller 121 and the counter-pressure roller 126. Deflection effects may thus be avoided. Moreover, a reliable electrical field at the runout 313 of the roller nip 310 may be ensured via the arrangement. Beyond that, a straight run of the recording medium 20 without additional contact with a front side of the recording medium 20 may be realized via the arrangement. Moreover, the offset of print image roller 121 and counter-pressure roller 126 enables a variation of the separation angles 302, 303 in the intake and runout, whereby a reduction of the meniscus length may be produced. Furthermore, the quality of the transfer process may be increased via the described arrangement such that additional fields of use of a printer 10 are enabled (for example for additional types of recording media 20).

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

10 digital printer
11, 11a-11d print group (front side)
12, 12a-12d print group (back side)
20 recording medium
20′ print image (toner)
20″ transport direction of the recording medium
21 roll (input)
22 take-off
23 conditioning group
24 turner
25 register
26 drawing group
27 take-up
28 roll (output)
30 fixer
40 climate control module
50 power supply
60 controller
70 fluid management
71 fluid control unit
72 reservoir
100 electrophotography station
101 image carrier (photoconductor, photoconductor roller)
102 erasure light
103 cleaning device (photoconductor)
104 blade (photoconductor)
105 collection container (photoconductor)
106 charging device (corotron)
106′ wire
106″ shield
107 supply air channel (aeration)
108 exhaust air channel (ventilation)
109 character generator
110 developer station
111 developer roller
112 storage chamber
112′ fluid supply
113 pre-chamber
114 electrode segment
115 dosing roller (developer roller)
116 blade (dosing roller)
117 cleaning roller (developer roller)
118 blade (cleaning roller of the developer roller)
119 collection container (liquid developer)
119′ fluid discharge
120 transfer station
121 print image carrier with print image roller (in particular transfer roller)
122 cleaning unit (wet chamber)
123 cleaning brush (wet chamber)
123′ cleaning fluid supply
124 cleaning roller (wet chamber)
124′ cleaning fluid discharge
125 blade
126 counter-pressure roller
127 cleaning unit (counter-pressure roller)
128 collection container (counter-pressure roller)
128′ fluid discharge
129 charging unit (corotron at transfer roller)
301 tensioning roller
302, 303 angle
310 roller nip/transfer location
311 intake region
312 central region
313 runout region
500 method for printing to a recording medium
501, 502, 503 method steps

What is claimed is:

1. A transfer station of a print group of a toner-based printer, comprising:
a print image carrier that is configured to transfer a print image inked with toner from the print image carrier onto a recording medium at a transfer location, the print image carrier including a print image roller and the recording medium being guided through the transfer station in a transport direction, wherein the toner is electrically charged;
a counter-pressure roller that is configured to press the recording medium against the print image roller at the transfer location, the counter-pressure roller being relatively hard in comparison to the print image roller to create a roller nip between the counter-pressure roller and the print image roller at the transfer location, wherein the roller nip includes: a central region in which both a print image carrier contact between print image carrier and the recording medium and a counter-pressure roller contact between the recording medium and counter-pressure roller exist, and a runout region in which the recording medium leaves the roller nip after transfer of the print image; and
a voltage source that is configured to generate a potential difference between print image roller and counter-pressure roller,
wherein a rotation axis of the counter-pressure roller is arranged after a rotation axis of the print image roller in the transport direction, such that, in the runout region, the print image carrier contact between print image carrier and the recording medium is ended before the counter-pressure roller contact between the recording medium and counter-pressure roller with respect to the transport direction, and such that an electrical field continues to act on the recording medium after the print image carrier contact between print image carrier and the recording medium has ended.

2. The transfer station according to claim 1, wherein the rotation axis of the counter-pressure roller is arranged after the rotation axis of the print image roller such that a ratio of a distance between the rotation axes in the transport direction and a direct distance between the rotation axes is greater than or equal to 5%, 10%, 15% or 20%.

3. The transfer station according to claim 1, wherein:
the roller nip further comprises an intake region in which the recording medium enters into the roller nip before transfer of the print image; and
the rotation axis of the counter-pressure roller is arranged after the rotation axis of the print image roller such that, in the intake region, the print image carrier contact between print image carrier and the recording medium is established before the counter-pressure roller contact between the recording medium and counter-pressure roller with respect to the transport direction.

4. The transfer station according to claim 3, wherein, in the intake region, the print image carrier contact is established at a predefined minimum duration before the counter-pressure roller contact.

5. The transfer station according to claim 1, wherein:
in the runout region, the print image carrier contact is ended at a predefined minimum duration before the counter-pressure roller contact;
a point of the recording medium traverses the roller nip in a traversal duration; and
a ratio between the predetermined minimum duration and the traversal duration is 5%, 10%, or more.

6. The transfer station according to claim 1, wherein:
the print image is inked on the print image carrier with a liquid toner; and
the liquid toner comprises toner particles and a carrier fluid.

7. The transfer station according to claim 1, wherein the recording medium is web-shaped and is supplied continuously to the transfer station.

8. A printer configured to print to a recording medium, comprising:
a plurality of print groups that are configured to successively print a corresponding plurality of toner-based print images onto a first side of the recording medium, the plurality of print groups respectively including a transfer station according to claim 1,
wherein the first side of the recording medium is only in contact with the respective print image carriers of the transfer stations of the plurality of print groups between an intake of a first print group of the plurality of print groups and an exit of a last print group of the plurality of print groups.

9. A method for printing to a recording medium, comprising:
guiding the recording medium to a transfer location between a print image roller of a print image carrier and a counter-pressure roller, the counter-pressure roller being relatively hard in comparison to the print image roller such that the print image roller and the counter-pressure roller form a roller nip at the transfer location, wherein the recording medium is guided in the roller nip such that the recording medium first forms a print image carrier contact with the print image carrier and only subsequently forms a counter-pressure roller contact with the counter-pressure roller;
transferring, in the roller nip, a print image inked with toner from the print image carrier onto the recording medium under effect of an electrical field between the print image roller and the counter-pressure roller, the toner being electrically charged, wherein both the print image carrier contact between print image carrier and the recording medium and the counter-pressure roller contact between the recording medium and counter-pressure roller exist in a central region of the roller nip; and
guiding the recording medium out of the roller nip such that the recording medium first ends the print image carrier contact with the print image carrier and only subsequently ends the counter-pressure roller contact with the counter-pressure roller, and such that the electrical field continues to act on the recording medium after the print image carrier contact between print image carrier and recording medium has ended.

10. A transfer station of a print group of a toner-based printer, the transfer station including the print image roller and the counter-pressure roller, and configured to perform the method of claim 9.

11. A method for printing to a recording medium, comprising:
guiding the recording medium to a transfer location between a print image carrier and a counter-pressure roller such that the recording medium first makes contact with the print image carrier and only subsequently makes contact with the counter-pressure roller;
transferring, at the transfer location, a print image inked with toner from the print image carrier onto the recording medium; and
guiding the recording medium away from the transfer location such that the recording medium first ends contact with the print image carrier and only subsequently ends contact with the counter-pressure roller.

12. A transfer station of a print group of a toner-based printer, the transfer station including the print image carrier and the counter-pressure roller, and configured to perform the method of claim 11.

13. A transfer station, comprising:
a print image roller that is configured to transfer a print image onto a recording medium at a transfer location, the recording medium being guided through the transfer station in a transport direction; and
a counter-pressure roller that is configured to force the recording medium against the print image roller at the transfer location, wherein contact between the print image roller and the counter-pressure roller creates a roller nip between the counter-pressure roller and the print image roller at the transfer location, wherein the roller nip includes: a central region in which the recording medium contacts the print image roller and the counter-pressure roller, and a runout region in which the recording medium leaves the roller nip after transfer of the print image,
wherein a rotation axis of the counter-pressure roller is arranged after a rotation axis of the print image roller in the transport direction such that, in the runout region, the recording medium remains in contact with the counter-pressure roller while creating a separation between the print image roller and the recording medium.

14. The transfer station according to claim 13, wherein the creation of the separation between the print image roller and the recording medium causes contact between the print image roller and the recording medium to end while the recording medium remains in contact with the counter-pressure roller.

15. The transfer station according to claim 13, the arrangement of the rotation axis of the counter-pressure roller after the rotation axis of the print image roller in the transport direction causes an electrical field to continue to act on the recording medium in the runout region.

16. The transfer station according to claim 13, wherein the counter-pressure roller is harder than the print image roller.
